(19) United States
(12) Patent Application Publication
(10) Pub. No.: US 2008/0013756 A1
(43) Pub. Date: Jan. 17, 2008

(54) MEDIA STORAGE MANAGER AND PLAYER

(75) Inventors: Christopher Roman, Wrentham, MA (US); Rob Voisey, Willingham (GB); John B. Clark, Somerset (GB); Logan J. Kunz, Cambridge (GB); Michael Leighton, Sun Prairie, WI (US); Gregor Mittersinker, Warwick, RI (US); Jacob Sigal, Blacklick, OH (US)

Correspondence Address: BARLOW, JOSEPHS & HOLMES, LTD., 101 DYER STREET, 5TH FLOOR, PROVIDENCE, RI, 02903, US

(73) Assignee: Numark Industries, LLC, Cumberland, RI (US)

(21) Appl. No.: 11/691,570

(22) Filed: Mar. 27, 2007

Related U.S. Application Data
(60) Provisional application No. 60/743,870, filed on Mar. 28, 2006.

(51) Int. Cl. H04B 1/00

(52) U.S. Cl. 381/119

(57) ABSTRACT

A media player for disc jockeys is disclosed. The media player includes a housing including a front face, a rear face, a left side and a right side. A plurality of input ports configured to connect a digital storage device containing a number of media tracks. A first and a second media output are included. The media player includes a first deck having a first media control interface configured to cue and play media tracks, and a second deck having a second media control interface configured to cue and play media tracks, and a global control interface including a main display screen divide into three portions. A digital mixing controller for accessing and controlling the digital storage device through the respective one of the respective input ports is also included.

### CROSS-REFERENCE TO RELATED APPLICATION

This application claims priority to earlier filed U.S. Provisional Application Ser. No. 60/743,870, filed Mar. 28, 2006, the contents of which are incorporated herein by reference.

### BACKGROUND OF THE INVENTION

1. Field of the Invention

The invention relates generally to equipment for playback and control of multimedia. More specifically, the present invention relates to disc jockey mixing equipment for control of the playback of multimedia files, such as audio and video files.

2. Background of the Related Art

In the music industry, there is a need for a person, such as a disc jockey, to be able to playback multimedia with control and precision. Such multimedia is available in many different forms. For example, it has been well known for many years that audio is available on analog vinyl discs. In particular, music recordings have been available on vinyl records and have been widely played by disc jockeys on turntables during a playback performance.

However, there is typically a need and desire to provide continuous music playback during a disc jockey performance. To carry this out, two or more turntables have been commonly employed whereby one turntable plays the current selection of music while the second turntable is used to cue up the next selection. When the first selection of music is nearing its end point or is at its end point, playback to the second turntable can be switched to the second turntable without interruption of the master output. It is also very well known that the transition from one turntable to another can be mixed or faded back and forth for seamless transition from one music selection to another. This back and forth transition and mixing can be carried out back and forth indefinitely during a disc jockey performance.

To carry out this mixing, a disc jockey mixing device is typically employed. The mixer commonly includes two inputs, one for each music source, such as a turntable, and a master output. A control interface is provided on the mixer so that the disc jockey can intuitively control the mixing and output of the media sources. This interface is critical so that the disc jockey can effectively control such mixing and playback output of the media for an engaging performance.

When turntables and vinyl records are used as the source for audio as the media, the cueing and playback of the audio are dictated by the turntable itself. The disc jockey must physically place the vinyl record on the turntable, place the needle on the desired spot and cue it up for playback when desired. When it is time for that selection to be outputted for playback, the mixer is manipulated to switch or fade to that selection so that it can be heard at the master output. When the selection is no longer desired, the turntable is the stopped by actuating the appropriate button or control on the turntable itself.

In general, the controls on the turntable itself are used to control playback and command operation of the turntable. As a result, disc jockey turntables provided with controls that are particularly well-suited for fast and easy control of a vinyl record. For example, play and cue buttons are typically very large and easily accessible, which is essential in a dark night club and where selection changes are frequent.

Vinyl records played back by turntables are a well known source of media for playback by a disc jockey, recently, there have been many new forms of digital media that are suitable for use by a disc jockey. For example, digital compact discs (CDs) are now a common storage format for media, such as digital audio. The digital audio is stored on an optical CD. Turntables are commonly substituted by compact disc players and mixed, as described above. Control of transport and operation of a CD and the audio files thereon can be carried out easily by providing disc jockey friendly operation controls thereon. For example, the playback/cue button can be large and intuitively placed on the CD player to facilitate the disc jockey performance.

In similar fashion to CDs, which store digital files on a optical disc, other storage media have been employed to store digital audio file for easy playback. For example, digital audio files can be stored on hard disks, memory RAM cards, USB thumb drives, and the like. These storage devices can also serve as the source of media files for later playback and mixing by a disc jockey. These storage devices can be separate units that serve as input sources for a disc jockey mixer, as an alternative media source for an analog turntable or CD player. For example, media players with hard disks and/or memory card slots for receipt of removable media are well known in the art. As with turntables and CD players, these are units that are provided with large and intuitive controls for playback and command of the media files. These controls are commonly specifically laid out and arranged for disc jockeys to facilitate their disc jockey performance.

It is also known in the art that CD players, hard disk players can be integrated with a disc jockey mixer for a single device solution. However, these units are still large enough and configured by design for use by disc jockeys.

Recently, portable media devices have become very popular for their compact size, large storage capacity and dropping cost. Portable media devices are available in the form of portable hard disk drives and, in particular, portable media players. These portable media players can playback audio files in many different formats, such as “mp3” and “wmv”. Also, many of these players can playback video files in different formats, such as “avi” and “divx”. For example, portable media players manufactured by Creative Technology Ltd., Apple Computer, Inc. and Archos, Inc. are widely sold with this capability.

These players typically include their own operating system and transport and command controls on the devices themselves so the user can playback and control files when desired. These portable devices are, essentially, personal players in that they are typically meant to be held in the hand or hands of the user so that the user can manipulate the controls for playback through headphones or a stereo system, for example.

While these transport and command controls are suitable for most uses of the portable players, there is often a need to enhance or improve the control of the personal player or connected mass storage class device for other uses. For example, remote controls have been provided for portable media players. A receiver is connected to the portable player that is interconnected with the operating system of the player. A wireless remote that uses infrared, for example, includes a duplication of some or all of the transport and command controls of the actual device. Pressing a button on the remote transmits commands to the receiver to thereby control operation of the portable player. Such a wireless remote is well suited for operating a portable player from a distance without having to touch the player itself.

Many portable devices include their transport and command controls on the front face of the player. If the player is in a case without only its top edge exposed, the entire player must be removed so that the controls can be manipulated. To address this problem, there are prior art control modules that can be plugged into the edge of a players, such through it headphone jack which commonly includes additional contacts for access to the players operating system.

Alternatively, some of the transport and command controls can be duplicated on a tethered connection to the player, such as inline with the headphones. Due to the small size that is feasible on a small tethered control, only the primary transport and command controls are provided thereon.

In the prior art, it has also been known to provide a dock for receipt of the portable player therein where some of the controls are repeated on the dock to facilitate use. For example, many stand alone powered speaker units that include a dock for a portable media player have such duplicated controls for use to obviate the user to manipulate the controls on the player itself.

While the controls on a portable players are sufficient for a person to manipulate while in their hand, these controls are not well suited for use by a disc jockey during a performance. Moreover, duplicated transport and command controls for a portable media player, such as those on tethered remotes, plug-in modules and powered speakers are inadequate for use by disc jockeys. They are not laid out in an intuitive or logical fashion for use by a disc jockey. Moreover, none of them provide mixing capabilities between more than one portable player. Also, none of them can stream and mix audio from the same or two different portable media devices. Further, none of the prior devices provide a way to mount the portable media player so its screen can be easily viewed in connection with its respective player controls. The prior art is also devoid of a device that has two separate dedicated sets of disc jockey style controls for each portable players.

In view of the foregoing, there is a demand for a digital mixing controller that can interconnect to portable media devices, such as mass storage devices, such as external hard drives and portable media players which have storage therein. There is a demand for a digital mixing controller apparatus for portable media devices that includes controls for command of operation of devices connected to the apparatus. There is another demand for an apparatus for portable media devices that can mix media streamed from one or more media devices connected thereto. There is a demand for a digital mixing apparatus that can control and command media stored on a connected mass storage device. There is yet another demand for an apparatus for portable media devices that displays media information thereon. There is a demand for an apparatus for portable media devices that can fully control the media thereon directly without having to access and control the operating system of the media device if it is a portable media player.

### SUMMARY OF THE INVENTION

The media player of the present invention preserves the advantages of prior art mixers and controllers portable media storage devices including portable media players. In addition, it provides new advantages not found in currently available devices and overcomes many disadvantages of such currently available devices.

The media player is generally directed to the novel and unique digital mixing controller apparatus for playing and controlling media, such as audio and video files, stored on an attached media storage device to the apparatus of the present invention.

The media player includes a new and unique digital mixing controller that provides not only a control interface for controlling and commanding media on a first portable media storage device but also provides its own unique operating system for directly controlling the media. Therefore, the connected media storage devices merely need to operate as a mass storage device where the apparatus can gain access to the files thereon. The apparatus of the present invention preferably does not access or use the media playback and operating system located on the device itself. The devices can be, for example, a portable external USB hard drive or portable media player with audio and/or video files thereon.

The apparatus includes a preferably rack-mountable housing with two sets of media controls thereon. The portable media storage devices are connected to the apparatus by USB ports or other known file transfer methodologies, such as IEEE-1394 and Bluetooth. A microcontroller resides in the housing and handles processing of media files. The first media controls and the second media controls are electrically interconnected to the microcontroller. One or more portable media storage devices with media items thereon are connected to the apparatus. As a result, the apparatus will have access to all of the media located on any of the connected storage devices.

The user interface is very flexible where tracks can be flagged, selected and grouped into playlists (or cue sets) for later playback and control. As a media item in the playlist next up for playback, it can be automatically sent to one side (i.e. A or B) or the other for control by the appropriate disc jockey interface controls located on the front of the apparatus. Thus, the disc jockey will not required to manually cue playback of a given file on a specific side. The apparatus can automatically control this which is a new and unique feature. Alternatively, a given media file may be manually placed on one side or the other for control by a given set of controls.

Manipulation of the first set of controls and second set of controls on the apparatus respectively commands operation of media items that have been assigned to it. Outputs connected to the portable media storage devices can be mixed and fully controlled in a disc jockey fashion. The levels of each side and master volume of the mixed outputs of the can be controlled.

### BRIEF DESCRIPTION OF THE DRAWINGS

These and other features, aspects, and advantages of the embodiments of the media player of the present invention will become better understood with reference to the following description, appended claims, and accompanying drawings where:

FIG. 1 is front perspective view of the preferred embodiment of the media player of the present invention;

FIG. 2 is a rear perspective view of the preferred embodiment of the media player of the present invention;

FIG. 3 is a front view of the preferred embodiment of the media player of the present invention;

FIG. 4 is a bottom view of the preferred embodiment of the media player of the present invention;

FIG. 5 is a plan view of an exemplary graphical interface of the media player and illustrates the step of activating the select feature of the media player by using the select knob to guide a cursor to the search selection in the menu;

FIG. 6 illustrates the step of selecting an album by using the select knob to guide a cursor to the album selection in the menu;

FIG. 7 illustrates the step of commencing a search of the available albums by guiding a cursor to the search selection in the menu using the select knob;

FIG. 8 illustrates the disc jockey entering the letter “d” into the search string using the select knob;

FIG. 9 illustrates the disc jockey further entering the letter “e” in to the search string using the select knob;

FIG. 10 illustrates the disc jockey executing the search by activating the multifunction key labeled “finish”;

FIG. 11 illustrates the search results obtained upon execution of the search described in FIGS. 6-10;

FIG. 12 illustrates the step of playing a desired album by guiding a cursor to the desired album and activating the multifunction control to assign the album to a desired deck labeled “A”;

FIG. 13 illustrates that the media tracks of the album are displayed after assigning the album to a deck to play;

FIG. 14 illustrates the step of viewing available artists on the media player using the exemplary graphical interface of the media player by using the select knob to guide a cursor to the artist selection in the menu;

FIG. 15 illustrates the step of commencing a search by artist by using the select knob to guide a cursor to the search selection in the menu;

FIG. 16 illustrates the disc jockey entering the letter “p” into the search string using the select knob;

FIG. 17 illustrates the disc jockey further entering the letter “r” in to the search string using the select knob and executing the search by activating the multifunction key labeled “finish”;

FIG. 18 illustrates the search results obtained upon execution of the search described in FIGS. 15-17;

FIG. 19 illustrates the results obtained by using the select knob to guide a cursor to the desired artist, “Prince”;

FIG. 20 illustrates the step of selecting a desired track and activating the multifunction control labeled “add”;

FIG. 21 illustrates the step of adding the desired track to the flag list (or crate);

FIG. 22 illustrates the step of using the multifunction control labeled “back” in order to move the contextual level up;

FIG. 23 illustrates the results of the execution of the step described in FIG. 22;

FIG. 24 illustrates the step of using the select knob to guide a cursor to the flag list (or crate) to view media tracks and albums that have been added thereto;

FIG. 25 illustrates the step of using the select knob and multifunction control to assign a media track to the second deck labeled “B”; and

FIG. 26 shows the media track is now cued and paused in the second deck labeled “B” by the second portion of the main display screen showing the indicia thereof.

### DESCRIPTION OF THE PREFERRED EMBODIMENT

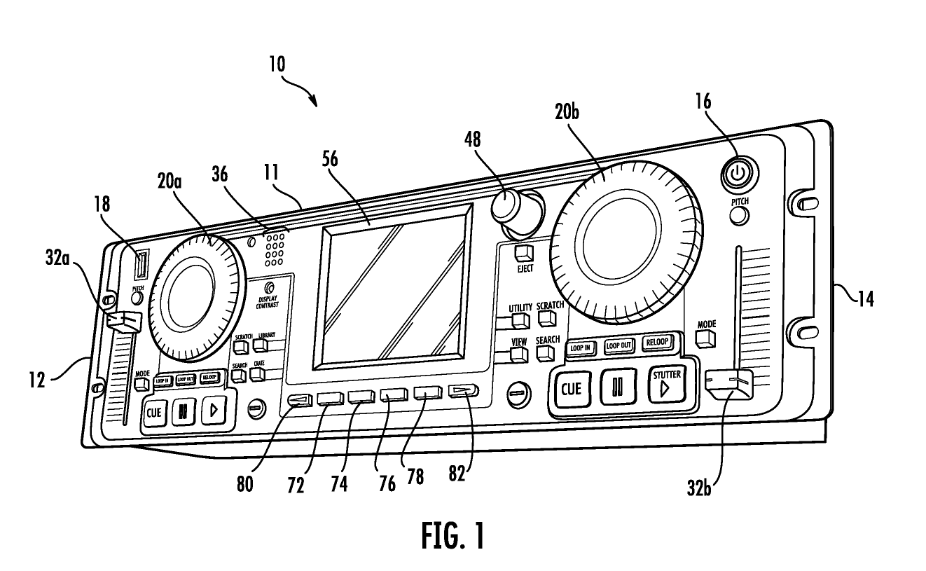

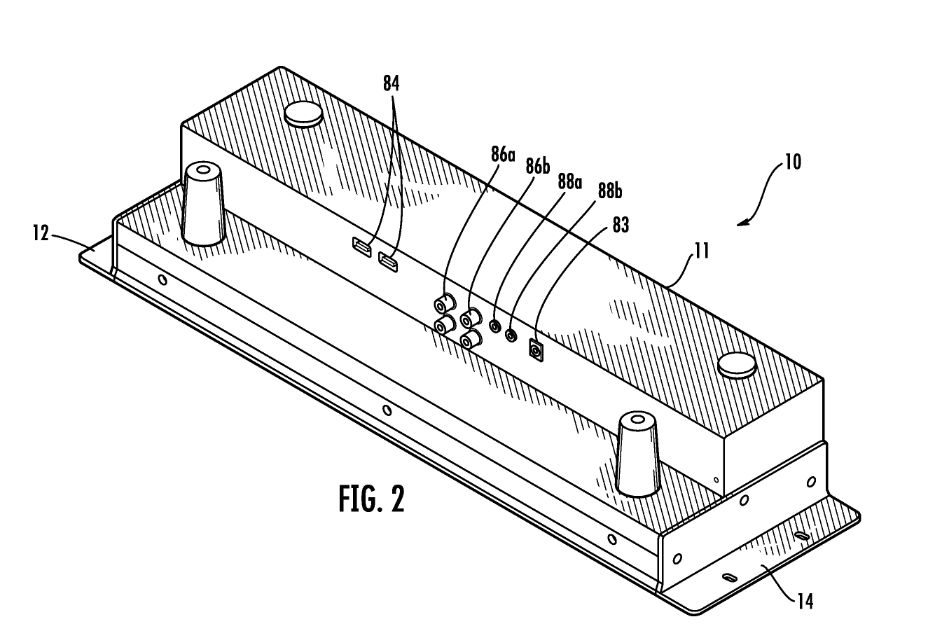

Referring now to FIGS. 1 and 2, the media player is shown generally at 10. The media player 10 includes a housing 11 having a front face and rear face. The housing 11 is configured generally to be rack mountable, and specifically includes mounting brackets 12, 14 extending outwardly from the sides of the housing 11. The housing 11 requires only 3 Us of space to fit into a rack (not shown). The front face of the housing 11 includes all of the controls for operating the media player 10, which will be described in greater detail below. The rear face of the housing 11 includes all of the connectors to connect the media player 10 to power, external amplifiers, audio sources, personal computers, speakers and the like, which will be described in greater detail below.

The media player 10 includes a digital mixing controller that provides not only a control interface for controlling and commanding media on a first portable media storage device but also provides its own unique operating system for directly controlling the media. Therefore, the connected media storage devices merely need to operate as a mass storage device where the apparatus can gain access to the files thereon. The apparatus of the present invention preferably does not access or use the media playback and operating system located on the device itself. The devices can be, for example, a portable external USB hard drive or portable media player with audio and/or video files thereon.

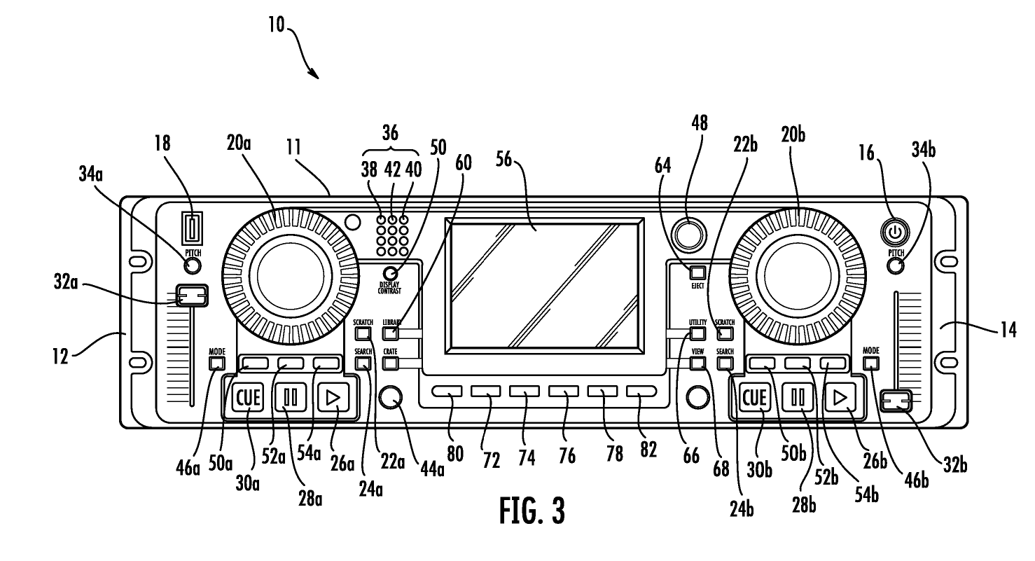

Referring to FIG. 3, the front face of the media player 10 includes a variety of controls for cueing and playing media content. The front face also includes the main power switch 16 to the media player 10, and a USB input port 18 for USB compatible peripherals. Although a USB input port 16 is shown other inputs ports could be used, such as an IEEE 1394 high speed serial bus or other data transfer ports.

The front face can be divided roughly into three control areas, a first interface to a first deck, a second interface to a second deck, and a central control interface. The first and second interfaces are identical in operation, but permit a disc jockey to cue, beat match, and play media independently on each corresponding deck. The central control interface includes global controls and the main display screen for both decks.

Located prominently in roughly the center of the each interface is a jog wheel control 20a, 20b. The jog wheel control 20a, 20b can be used for pitch bending, scratching and searching through the music playing on the respective deck. The functionality of the jog wheel control 20a, 20b is determined by the accompanying scratch control 22a, 22b and search control 24a, 24b.

While a media track is playing on the respective deck, the jog wheel control 20a, 20b functions as a pitch bend. Pitch bending temporarily speeds up (turn clockwise) or slows down (turn counter-clockwise) the media. This technique is used when to adjust two beat-matched tracks that may not be completely synchronized. Hence, with pitch bending a disc jockey can temporarily slow down or speed up the track that is being mixed so its beats are synchronous with the beats of the other track that is already playing on the other deck.

While a media track is paused, a disc jockey can use the jog wheel control 20a, 20b to seek through the music to a new cue point location. Activating the respective play/stutter control 26a, 26b following the adjustment of the jog wheel control 20a, 20b sets the cue point at the new selected location.

A scratch control 22a, 22b is provided adjacent to each respective jog wheel control 20a, 20b to engage scratch mode. In scratch mode, the jog wheel control 20a, 20b allows a disc jockey to apply a scratch-effect to the media track in much the same way that disc jockeys scratch a vinyl record. As the media track is playing, shifting the jog wheel control 20a 20b back and forth creates a scratching effect. When the jog wheel control 20a, 20b is held stationary, normal playback of the media track resumes. To resume play with no gap in the audio, “push off” by scratching forward at approximately normal playback speed before releasing the jog wheel control 20a, 20b.

Also adjacent to each jog wheel control 20a, 20b is a respective search control 24a, 24b to engage search mode. Search mode allows the disc jockey to use the jog wheel control 20a, 20b to quickly scan through the current media track. If the disc jockey does not touch the jog wheel control 20a, 20b for a short period (approximately eight seconds) the respective deck automatically exits search mode.

A play/stutter control 26a, 26b is included on each respective deck. Activating the play/stutter control 26a, 26b starts the currently selected in the deck. A cue point is set at the current position and the media begins playing. Activating the play/stutter control 26a, 26b while the media player 10 is playing restarts the media from the cue point, which can be used to create a “stutter” effect.

Adjacent to each play/stutter control 26a, 26b is a pause control 28a, 28b. The pause control 28a, 28b stops the media track playing on the corresponding deck. Activating and holding the pause control 28a, 28b for approximately one second while paused, returns the playback of the media to the beginning of the selected track.

Adjacent to each pause control 28a, 28b is a cue control 30a, 30b. The cue control 30a, 30b returns and simultaneously pauses the media at the last set cue point. As described earlier, a cue point is the last place where play/stutter control 26a, 26b was activated or the start of the track, if the play/stutter control 26a, 26b has not been activated. By activating and holding the cue control 30a, 30b, the respective deck of the media player 10 will begin playing the selected media track for as long as the cue control 30a, 30b is held active. Once the cue control 30a, 30b is released, the media player 10 will jump back and pause at the cue point.

A cue point can be easily edited by spinning the jog wheel control 20a, 20b to a new position while paused. As the disc jockey spins the jog wheel control 20a, 20b, the media track will sound. By stopping the jog wheel control 20a, 20b and activating the play/stutter control 26a, 26b, a new cue point is set.

Each deck includes a pitch slider control 32a, 32b, which is used to control the speed (or pitch) of the media track. Moving the slider toward “−” results in a lower pitch (and slower tempo) of the media track, while moving the slider toward “+” results in a higher pitch (and faster tempo) of the media track.

Working in conjunction with each pitch slider control 32a, 32b is a pitch adjustment control 34a, 34b. The pitch adjustment control 34a, 34b adjusts the range (or precision) of control the pitch slider control 32a, 32b has on the overall tempo of media trck. Activating the pitch adjustment control cycles through pitch ranges of ±0, 6, 12, 25, and +25/−100%, although other ranges could be used. Selecting 0 will deactivates the pitch slider control 32a, 32b.

Different pitch ranges allow for different precision over the speed of the media track. Selecting a smaller pitch range, such as ±6%, allows the disc jockey to have more precise control over the speed of the media track. Selecting a larger pitch range, such as +25/−100%, allows for more extreme speed adjustments and can be used for interesting special effects.

The media player 10 includes a beat keeper that automatically tracks beats based upon a combination of frequencies and rhythm patterns in the media currently playing. It shows beats per minute (“BPM”) in a beat display 36 and outputs 4-count (i.e. one measure) information about the media track in a marching bar graph. The beat display 36 includes a left bar 38, a right bar 40 and a middle bar 42. The left bar 38 represents the beat of the media playing on the first deck, while the right bar 40 represents the beat of the media playing on the second deck. The middle bar 42 indicates when the downbeats of the media playing on both decks occur simultaneously in order to aid the disc jockey in beat matching two different tracks of media.

A tap control 44a, 44b is provided adjacent to the search control 24a, 24b on each deck. Activating the respective tap control 44a, 44b in time with the beat of the media currently playing will aid the beat keeper in detecting the proper tempo. Activating and holding active the tap control 44a, 44b for approximately one second resets the beat keeper and causes it to recalculate the BPM.

A mode control 46a, 46b is also provided on each interface. Activating the mode control 46a, 46b invokes a menu on the main display screen 56 that includes deck options, such as pitch range, time display and fader start. The disc jockey can subsequently use the select knob 48, described in detail below, to dial in the desired values and pressing down on the select knob 48 will move on to the next option. Activating the mode control 44a, 44b again exits the deck options menu.

Each interface also includes a set of loop controls. In particular, there is a loop in control 50a, 50b, a loop out control 52a, 52b, and a re-loop control 54a, 54b.

The loop in control 50a, 50b is used to set a “loop in” point in the media track. By default, a “loop in” point is automatically set to the current cue point (which defaults to the beginning of the track). A new “loop in” point is defined by activating the loop in control 50a, 50b when the media track reaches the desired point. A loop in indicator within the loop in control 50a, 50b will light, indicating a new “loop in” point has been set. A new loop in point can be set by merely activating the loop in control 50a, 50b again at the new desired location within the media track.

The loop in control 50a, 50b can also be used to create a new cue point. Activating the loop in control 50a, 50b sets a cue point will be set at that location also. The disc jockey can return to this new cue point by activating and holding cue control 30a, 30b while simultaneously activating the loop in control 50a, 50b. The deck will pause and return to the loop in point. Playback can be resumed by subsequently activating the play/stutter control 26a, 26b.

The loop out control 52a, 52b is used to set the end point of the loop. The first time the loop out control 52a, 52b is activated while a media track is playing, an indicator in the loop out control 52a, 52b will blink and the media track will begin playing in a seamless loop starting from the “loop in” point and ending at the “loop out” point. To release or end the loop, the loop out control 52a, 52b is activated a second time. Play continues forward when the media track passes the previously set loop out point. The indicator in the loop out control 52a, 52b will continuously light, indicating that the loop is now stored in memory for re-looping purposes later.

Like the loop in control 50a, 50b, the loop out control 52a, 52b can also be used to create a new cue point. Activating the loop out control 52a, 52b sets a cue point at that location also. The disc jockey can return to this new cue point by activating and holding cue control 30a, 30b while simultaneously activating the loop out control 52a, 52b. The deck will pause and return to the loop out point. Playback can be resumed by subsequently activating the play/stutter control 26a, 26b.

The re-loop control 54a, 54b repeats play of the media track from the loop in point. If a loop has been set, it plays and repeats a previously set loop, until it is released by activating the loop out control 52a, 52b. By activating the re-loop control 54a, 54b repeatedly, a stutter effect can be made.

The central control interface contains the global controls for the media player, such as navigation and function controls, as well as the beat keeper display 36 and the main display screen 56. The main display screen 56 displays information about the media player, the decks and any attached peripheral devices, such as removable hard discs or portable media playing devices.

Adjacent to the main display screen 56 is a menu select knob 48. The menu select knob 48 is used to navigate lists, change settings, and operate various parts of the user interface. The menu select knob 48 can be rotated and pressed to select or change a highlighted item within the user interface menus displayed on the main display screen 56.

Also adjacent to the main display screen 56 is a display contrast control 58. The display contrast control 58 is used to increase or decrease the contrast of the main display screen 56 to enable viewing under various lighting conditions.

Below the display contrast control 58 is a library selection control 60. The library selected control 60 allows the disc jockey to access the library of media stored on removable media connected to the media player through one of the USB ports 18, 84.

Below the library selection control 60 is a crate control 62. The crate control 62 allows the disc jockey to view the media tracks that have been labeled as being in the crate (or flag list). While viewing media tracks in the crate (or flag list), the disc jockey can use the multifunction controls 70, 72, 74, 76, 78 below the main display screen 56 to send tracks to either deck for mixing, pull them back into the crate for later use if they are already playing, or remove them from the crate altogether. The disc jockey may also switch the media track order in the crate, by using the selected knob 48.

On the opposite side of the main display screen 56 and below the select knob 48 is an eject control 64. Activating the eject control 64 enables the disc jockey to select a mass storage device connected to the media player 10 to dismount. When the eject control 64 is activated, a list of the devices currently attached to the media player 10 is displayed on the main display screen 56. The disc jockey uses the select knob 48 to select the desired device to be ejected.

Below the eject control 64 is a utility control 66. Activating the utility control 66 invokes a utility menu to display on the main display 56. In the utility menu, the disc jockey can adjust display preferences, restore settings to their factory default state and calibrate the pitch sliders 32a, 32b.

Below the utility control 66 is a view control 68. The view control 68 is used to access different information about the media playing on either of the decks. The view control 68 also toggles between track information and a track profile view of the media track playing.

A track profile is a visual representation of a media track, designed for quick and easy identification of phrases or segments within that media track, differentiated by their “energy”. Distinct from a waveform, a profile doesn't show every small detail of the track, just the big changes in terms of energy.

The track profile is split into three shades of grey, with black making up the total number of variations to four. The white portions of the track indicate high energy and volume, graduating down to the black sections representing quieter phrases. The length of each profile is scaled to exactly fit the available work area on the main display screen 56, so the entire track is always visible.

Four multifunction controls 72, 74, 76, 78 are found below the main display screen. The four multifunction controls 72, 74, 76, 78 are used to select from available menu items displayed on the on the main display screen 56. Depending on the menu that is being viewed, the functionality of the individual multifunction controls 72, 74, 76, 78 will change. The main display screen 56 will display one or more icons directly above each multifunction controls 72, 74, 76, 78 indicating the function of each particular multifunction control 72, 74, 76, 78, respectively.

On either side of the four multifunction controls 72, 74, 76, 78 are a left page control 80 and right page control 82. The left page control 80 and the right page control 82 are used to scroll through available pages of selections, when available. If there are additional pages to be viewed, a left or right arrow icon is displayed on the display screen above the left or right page controls 80, 82, respectively. The left page control 80 and the right page control 82 are also used to move a cursor 96 when entering text in the main display screen 56.

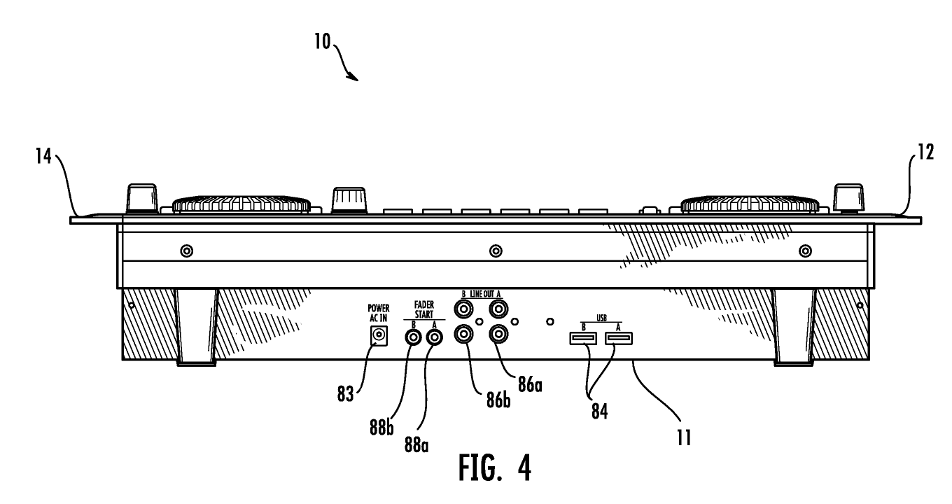

Referring now to FIG. 4, the media player 10 includes a number of connectors or adapters on the rear face of the housing. In particular, the media player includes a power input 83 to supply power to the media player, a pair of USB ports 84, a dual set of line outputs 86a, 86b, and a fader start input 88.

The USB ports 84 can be used to attach mass storage devices to the media player 10 and other USB compatible devices. For instance a USB compatible keyboard can be attached to permit text entry in the media player 10 rather than using the select knob 48 and left and right page controls 80, 82. The two available USB ports 84 may be expanded through use of an optional USB hub.

The media player 10 includes two line output ports 86a, 86b. The first line output port 86a is configured as an RCA connection and outputs the audio signal from the first deck. The second line output 86b port is also configured as an RCA connection and outputs the audio signal from the second deck. The two line outputs 86a, 86b and be attached to a separate mixing console and transmitted to speakers for the audience.

The media player 10 also includes fader start connectors 88a, 88b. The fader start connectors 88a, 88b may be connected to a fader-start compatible mixer. Fader start allows a disc jockey to remotely start playback on either deck of the media player from a fader-start compatible mixer. With this feature, every time a disc jockey moves a crossfader control on a fader-start compatible mixer from one input to the other, the track loaded on that respective deck begins to play.

The media player 10 is capable of playing media files stored in popular formats, such as MP3, WAV and AAC music formats. Moreover, the media player 10 is capable of reading and controlling file systems stored in FAT16, FAT32, NTFS (read-only) and HFS+ formats. The media player 10 directly controls devices in these formats rather than working through the device itself or a proxy. This feature allows the media player 10 to be responsive and avoids latency and compatibility problems.

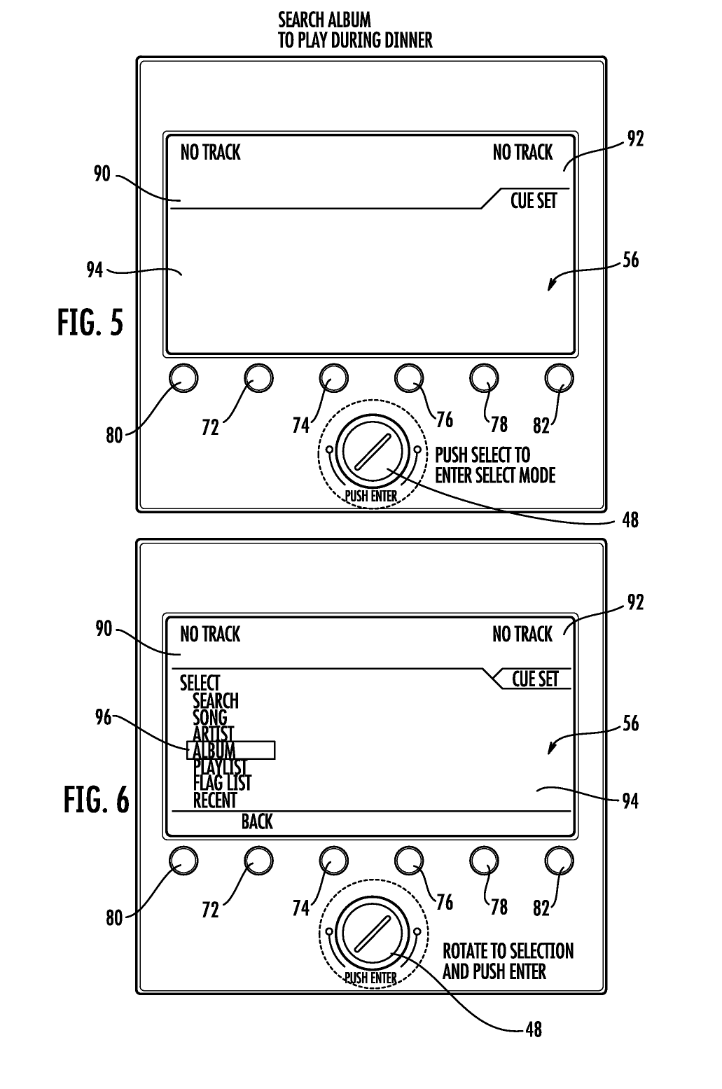

Turning now to FIG. 5, a close up view of an embodiment of the main display screen 56 and central control interface is shown. The main display screen is divided into roughly three display areas. The upper left portion 90 of the main display screen 56 includes information relating to the first deck. The upper right portion 92 of the main display screen 56 includes information relating the second deck. The lower portion 94 of the main display screen 56 includes the menus for selecting media and setting the options of the media player 10. The lower portion 94 also includes the menu bar that indicates the functions of the various multifunction controls 72, 74, 76, 78 below the main display screen 56.

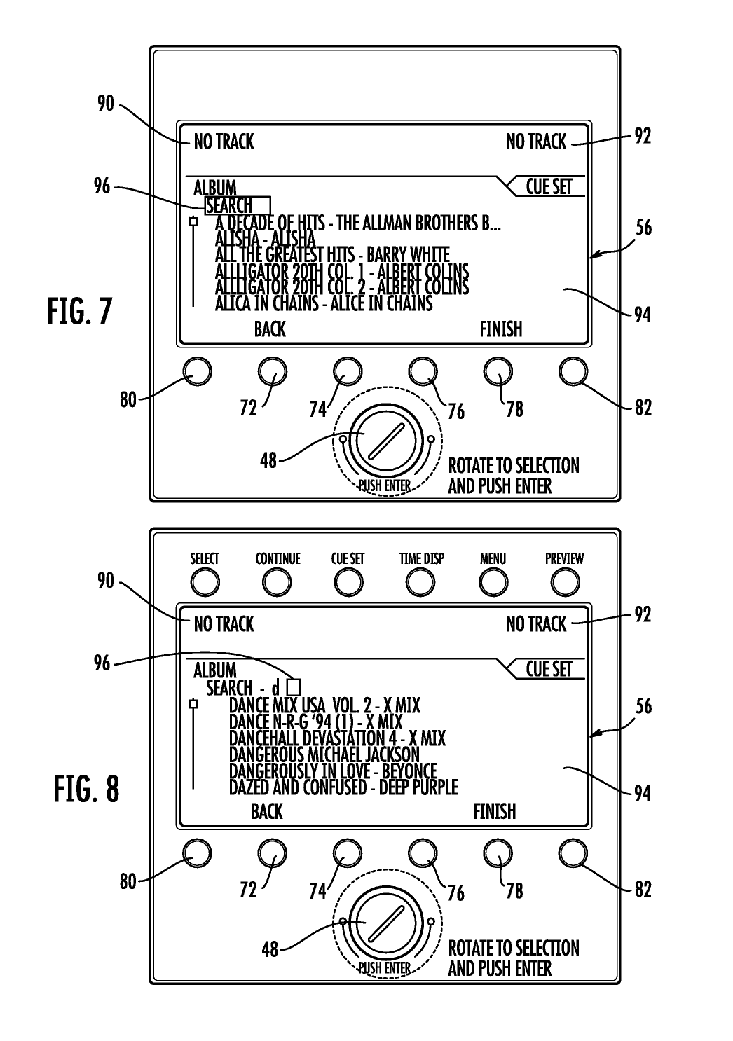

Pressing either the crate control 62 or the library control 60 invokes a select menu that is displayed on the lower portion 94 of the main display screen 56 shown in FIG. 6. The library control 60 displays all media tracks available, whereas the crate control 62 only shows a select portion of all the media tracks available. The lists are organized by song, artist, album, playlist, flag list (or crate) and recently played media tracks. The disc jockey can then rotate the select knob 48 to cause a cursor 96 to highlight a desired choice in the menu on the lower portion 94 of the main display screen 56, such as available albums for instance, and press the select knob 48 to select the desired choice. Referring the FIG. 7, after selecting the album selection, a list of all available albums is displayed in the lower portion 94 of the main display screen 56.

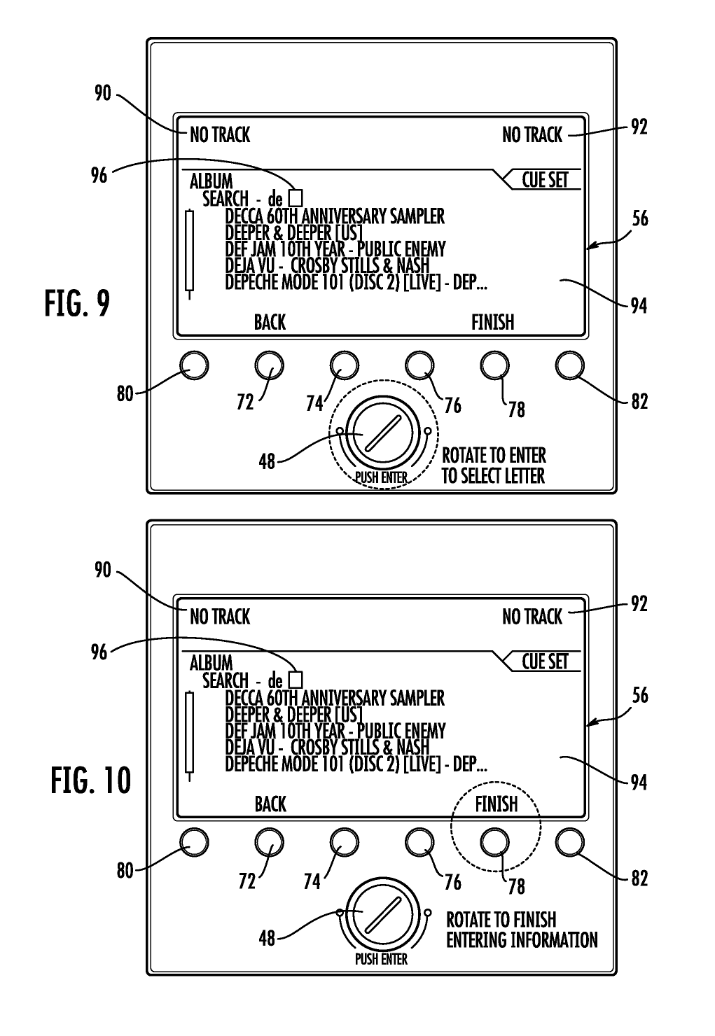

If the disc jockey desires to search for a particular album, the disc jockey uses the select knob 48 to move the cursor 96 to highlight the search selection on the menu 94 and presses the select knob 48 as shown in FIG. 7. After pressing the select knob 48, the disc jockey may enter the text of the characters that the disc jockey desires to search on by rotating and pressing the select knob 48. For example, referring the FIGS. 8 and 9, the disc jockey has selected the letters “d” and “e”. After the desired text is entered, the disc jockey may execute the search by activating the multifunction control 78 that is indicated as “finish”, as shown in FIG. 10. Alternatively, the disc jockey may enter text using a keyboard attached to one of the USB ports 18, 84 as described above.

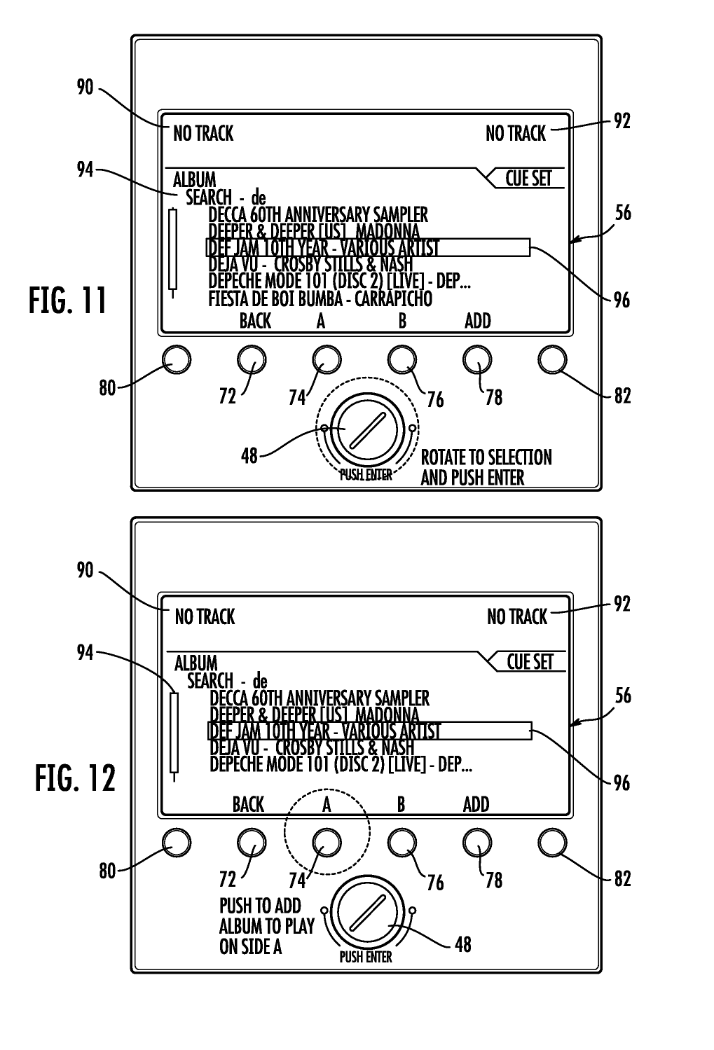

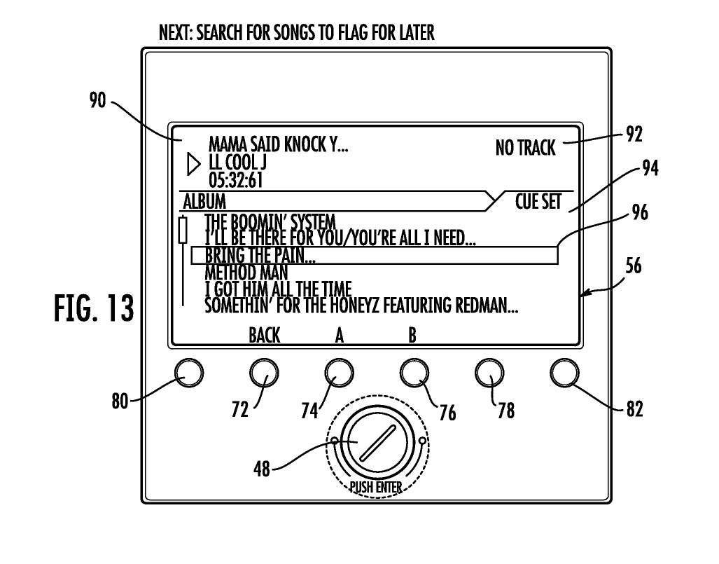

Referring to FIG. 11, a list of all albums with titles beginning with the letters “de” is displayed. The disc jockey can then select with the cursor 96 and assign an entire album to one of the decks by using the select knob 48 and desired multifunction control 74 as shown in FIG. 12. Referring to FIG. 13, after assigning the album to one of the decks, a list of the media tracks within the album is displayed and the first media track begins play. The first portion 90 of the main display screen 56 indicates that the first track of the album is now playing.

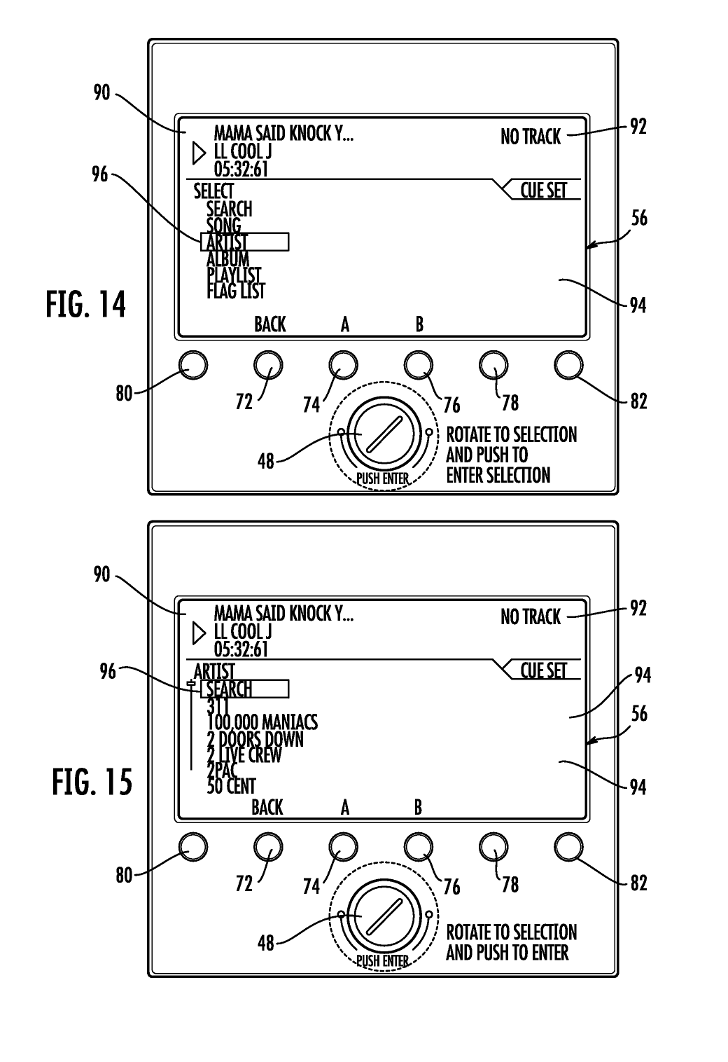

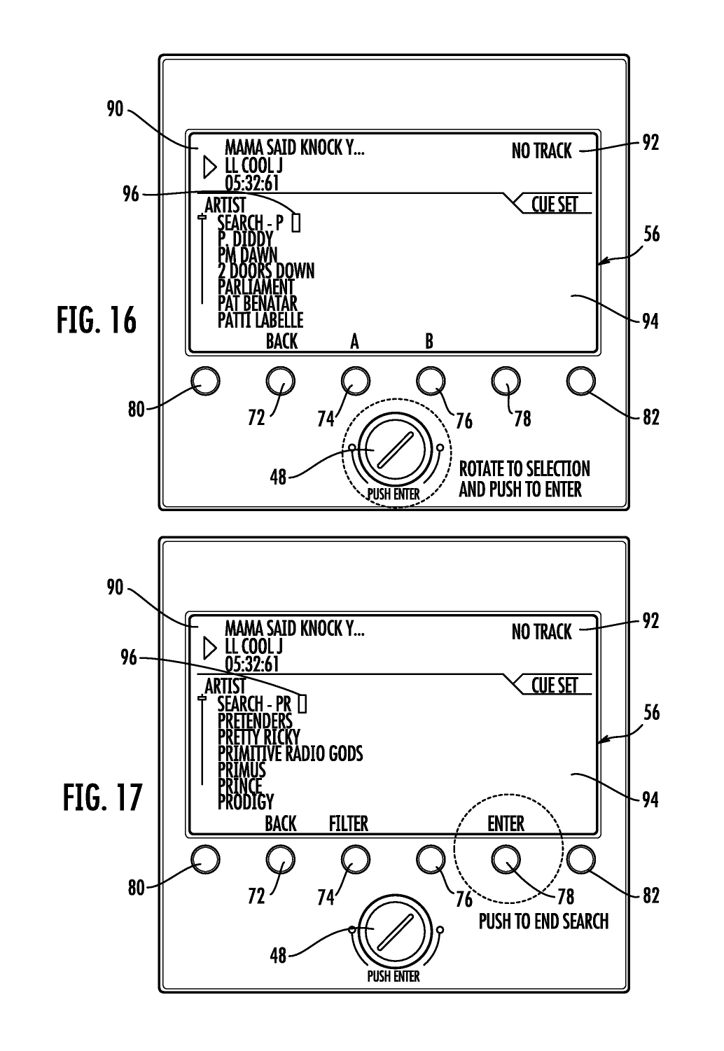

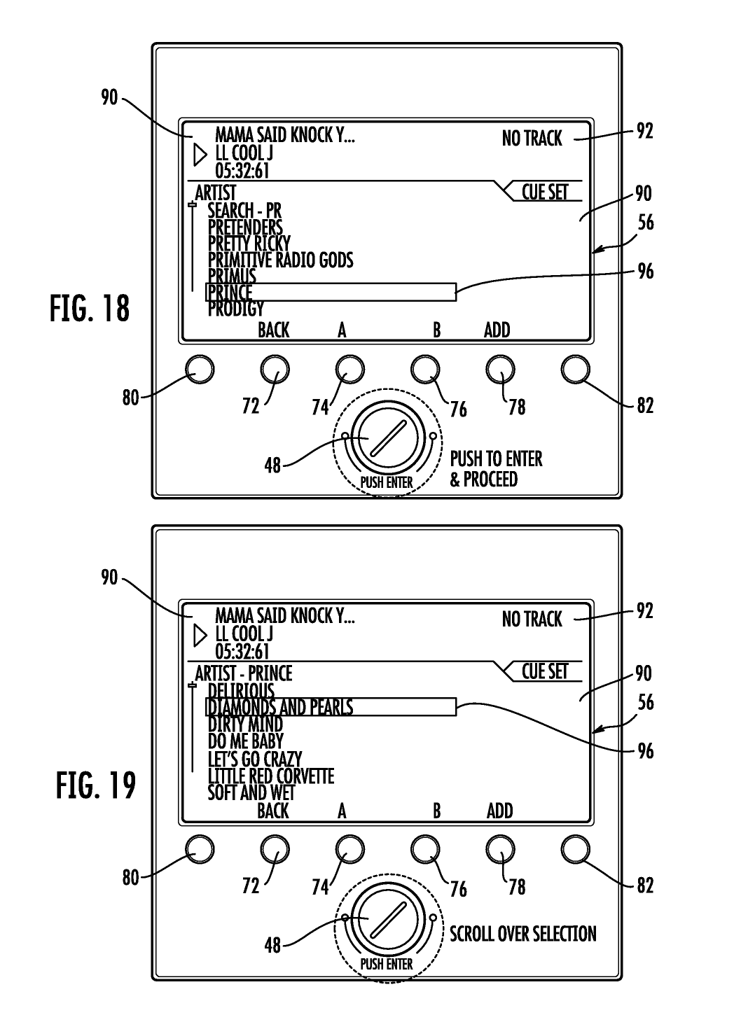

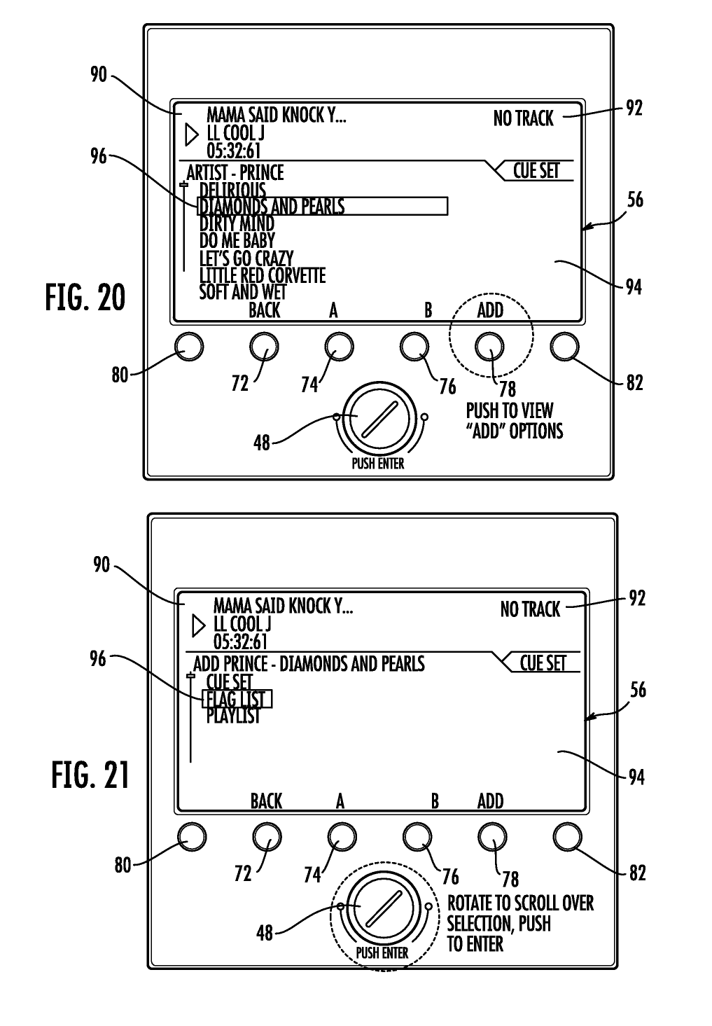

If the disc jockey desires to cue more media tracks to play, he merely activates the library control 60 or crate control 62 to return the main menu 56 as shown in FIG. 14. For instance, if the disc jockey desires to add music to the play list from a particular artist, the disc jockey uses the select knob 48 to guide the cursor 96 to the artist selection on the menu in the lower portion 94 and presses the select knob 48. A list of available artists is then displayed in the lower portion 94 as shown in FIG. 15. If the disk jockey desires to search for media tracks by the artist Prince, for instance, the disc jockey selects the search icon in the list. Referring to FIGS. 16 and 17, the disc jockey can then enter the letters “p” and “r” with the select knob 48 or keyboard and activate the multifunction key labeled “enter” 78 to commence the search. Referring to FIG. 18, a list of all artists with titles beginning with the letters “pr” is displayed in the lower portion 94. The select knob 48 can then be used to select “prince” from the list. Referring to FIG. 19, a list of all of the media tracks by the artist Prince is displayed. The disc jockey can then use the select knob 48 to guide the cursor 96 to the title of a particular media track. By using the multifunction control labeled “add” 78, as shown in FIGS. 20 and 21, the disc jockey can then append the selected media track the flag list (or crate), a playlist, or, alternatively, set a cue point within the track.

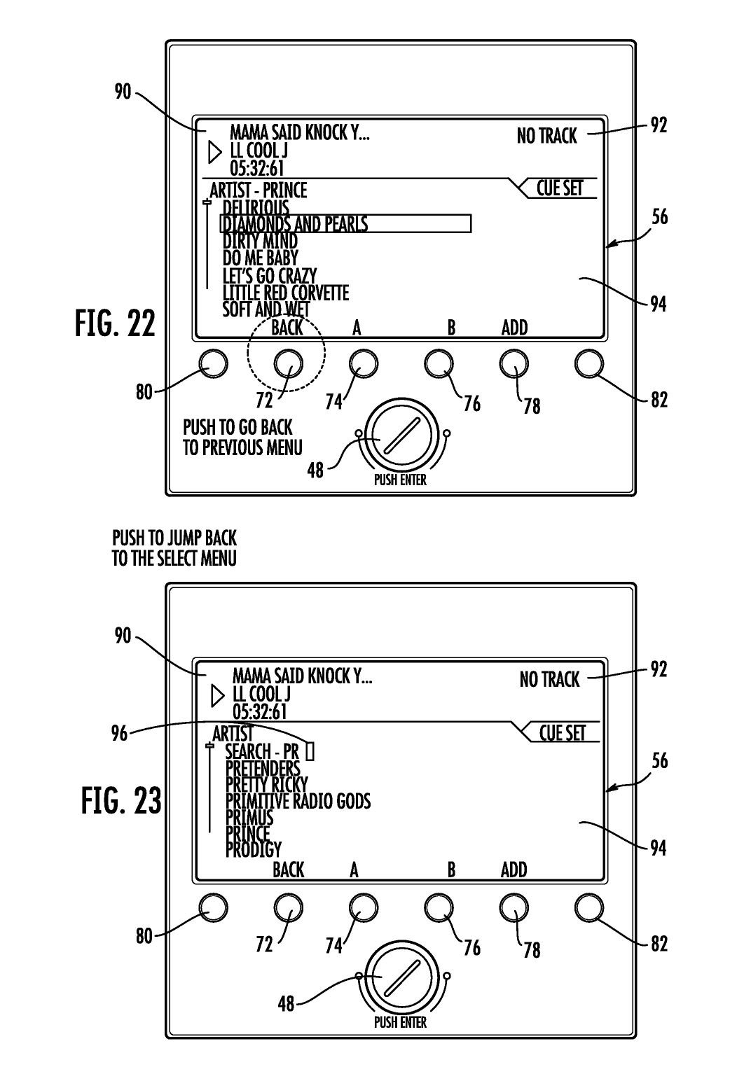

Referring to FIGS. 22 and 23, activating the multifunction control labeled “back” 72 brings the cursor up one contextual level.

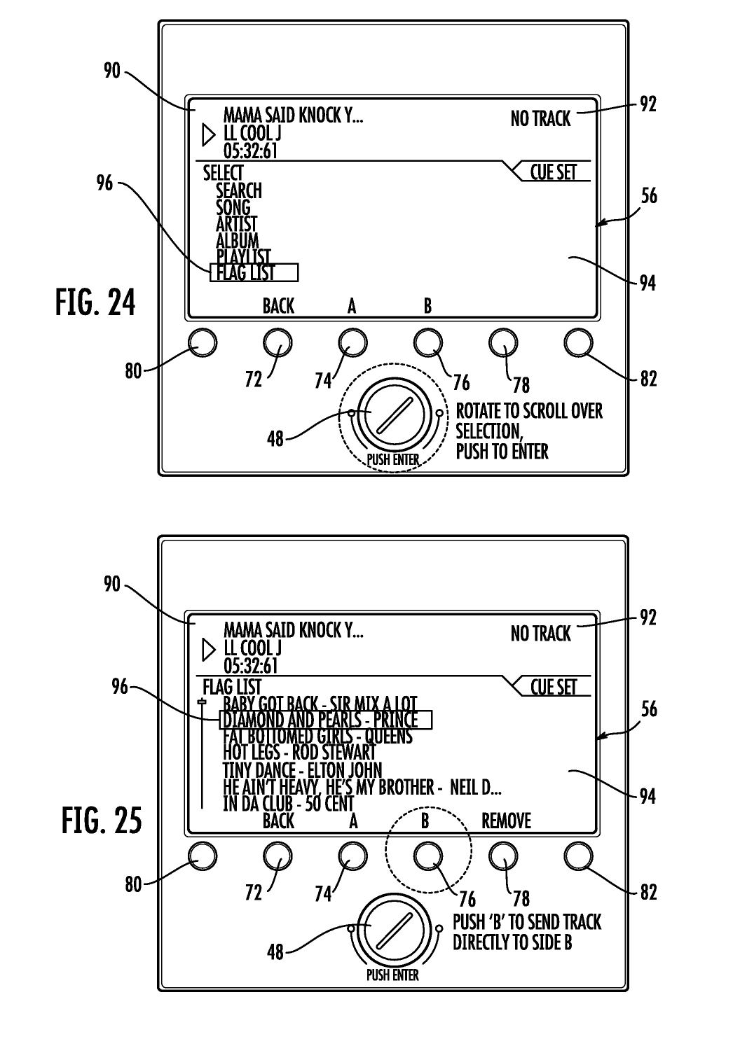

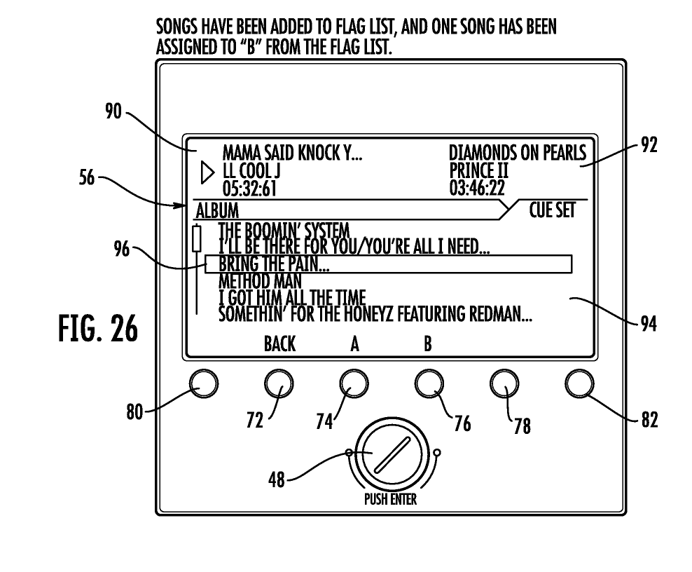

Referring to FIG. 24, the disc jockey can view the contents of the crate or the flag list by one of two methods. In particular, the disc jockey can activate the crate control 62 as described above earlier, or the disc jockey may use the select knob 48 from the library control menu to select the flag list (or crate). In either case, the contents of the crate are displayed as shown in FIG. 25. The disc jockey my then cue and play a media track on the second deck, for instance, by selecting the media track by using the select knob 48 to guide the cursor 96 to the desired selection and subsequently activating the appropriate multifunction control 72, 74. The selected track is then displayed in the second portion 92 of the main display screen 56 as indicated on FIG. 26.

Media tracks may also be searched for and selected by song title, recently played and playlist also. Through use of the select knob 48 and multifunction controls 72, 74, 76, 78, playlists may be created and media tracks added thereto.

Therefore, it can be seen that the media player of the present invention provides a unique solution to the problem of providing an apparatus for a disc jockey that includes a unique graphical user interface to enable a disc jockey to manage external libraries of media tracks, yet still includes dual decks and dual sets of disc jockey specific controls that disc jockeys need during performances. The media player of the present invention enables a disc jockey to concentrate on the creative aspects of his or her performance and focus less on the function and operation of the performance equipment.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A media player for disc jockeys, comprising:
a housing including a front face, a rear face, a left side and a right side,
a plurality of input ports configured and arranged to operatively connect a digital storage device containing a plurality of media tracks;
a first media output;
a second media output;
a first deck having a first media control interface configured and arranged to cue and play media tracks, said media tracks being outputted through said first media output, said first media control interface located on said front face of said housing;
a second deck having a second media control interface configured and arranged to cue and play media tracks, said media tracks being outputted through said second media output, said second media control interface located on said front face of said housing;
a global control interface including a main display screen located on said front face of said housing, a select knob being rotatable and pressable for navigating menus and selecting menu choices contained therein, and plurality of multifunction controls having contextual function labels associated therewith for navigating menus and selecting menu choices contained therein; and
a digital mixing controller for accessing and controlling said digital storage device through the respective one of said plurality of input ports according to selections made on said first interface, said second interface and said global control interface.

2. The media play of claim 1, further comprising:
a left rack mount extending from the left side of the housing; and
a right rack mount extending from the right side of said housing.

3. The media player of claim 1, further comprising:
a first fader start connector and a second fader start connector;
said first fader start connector causing said first deck to play upon receiving an input signal thereto and pause upon receiving another input signal thereto;
said second fader start connector causing said second deck to play upon receiving an input signal thereto and pause upon receiving another input signal thereto.

4. The media player of claim 1, further comprising:
a beat keeper having first display, second display and third display;
said first display indicating the beats of a media track playing on said first deck;
said second display indicating the beats of a media track playing on said second deck;
said third display indicating when the downbeats of the media tracks playing on the first deck and second deck, respectively, occur simultaneously.

5. The media player of claim 1, further comprising:
a crate control for sorting a portion of said plurality of media tracks into a set for use at a disc jockey performance.

6. The media player of claim 1, wherein said third portion of said main display screen further includes said third indicia of said plurality of media tracks organized by artist, album, playlist, and song title, respectively.

7. The media player of claim 1, further comprising a view control, said view control displaying a first track profile of a first media track playing on the first deck juxtaposed to a second track profile of a second media track playing on the second deck on the third portion of the main display screen to provide a graphical representation of the energy to the first media track and the second media track.

8. The media player of claim 1, wherein the digital storage device is a removable hard drive.

9. The media player of claim 1, wherein the digital storage device is a removable thumb drive.

10. The media player of claim 1, wherein the digital storage device is a portable personal media player.

11. The media player of claim 1, wherein said main display screen further comprises:
a first portion containing first indicia of said first deck;
a second portion containing second indicia of said second deck; and
a third portion containing third indicia of said plurality of media tracks;

12. A media player for disc jockeys, comprising:
a housing including a front face, a rear face, a left side and a right side,
a plurality of input ports configured and arranged to operatively connect a digital storage device containing a plurality of media tracks;
a first media output;
a second media output;
a first deck having a first media control interface configured and arranged to cue and play media tracks, said media tracks being outputted through said first media output, said first media control interface located on said front face of said housing;
a second deck having a second media control interface configured and arranged to cue and play media tracks, said media tracks being outputted through said second media output, said second media control interface located on said front face of said housing;
a global control interface including a main display screen located on said front face of said housing, a select knob being rotatable and pressable for navigating menus and selecting menu choices contained therein, and plurality of multifunction controls having contextual function labels associated therewith for navigating menus and selecting menu choices contained therein;
said main display screen having a first portion containing first indicia of said first deck, a second portion containing second indicia of said second deck, and a third portion containing third indicia of said plurality of media tracks; and
a digital mixing controller for accessing and controlling said digital storage device through the respective one of said plurality of input ports according to selections made on said first interface, said second interface and said global control interface.

13. The media play of claim 12, further comprising:
a left rack mount extending from the left side of the housing; and
a right rack mount extending from the right side of said housing.

14. The media player of claim 12, further comprising:
a first fader start connector and a second fader start connector;
said first fader start connector causing said first deck to play upon receiving an input signal thereto and pause upon receiving another input signal thereto;
said second fader start connector causing said second deck to play upon receiving an input signal thereto and pause upon receiving another input signal thereto.

15. The media player of claim 12, further comprising:
a beat keeper having first display, second display and third display;
said first display indicating the beats of a media track playing on said first deck;
said second display indicating the beats of a media track playing on said second deck;
said third display indicating when the downbeats of the media tracks playing on the first deck and second deck, respectively, occur simultaneously.

16. The media player of claim 12, further comprising:
a crate control for sorting a portion of said plurality of media tracks into a set for use at a disc jockey performance.

17. The media player of claim 12, wherein said third portion of said main display screen further includes said third indicia of said plurality of media tracks organized by artist, album, playlist, and song title, respectively.

18. The media player of claim 12, further comprising a view control, said view control displaying a first track profile of a first media track playing on the first deck juxtaposed to a second track profile of a second media track playing on the second deck on the third portion of the main display screen to provide a graphical representation of the energy to the first media track and the second media track.

19. The media player of claim 12, wherein the digital storage device is a removable hard drive.

20. The media player of claim 12, wherein the digital storage device is a removable thumb drive.

21. The media player of claim 12, wherein the digital storage device is a portable personal media player.

22. A media player for disc jockeys, comprising:
a housing including a front face, a rear face, a left side and a right side,
a plurality of input ports configured and arranged to operatively connect a digital storage device containing a plurality of media tracks;
a first media output;
a second media output;
a first deck having a first media control interface configured and arranged to cue and play media tracks, said media tracks being outputted through said first media output, said first media control interface located on said front face of said housing;
a second deck having a second media control interface configured and arranged to cue and play media tracks, said media tracks being outputted through said second media output, said second media control interface located on said front face of said housing;
a global control interface including a main display screen located on said front face of said housing, a select knob being rotatable and pressable for navigating menus and selecting menu choices contained therein, and plurality of multifunction controls having contextual function labels associated therewith for navigating menus and selecting menu choices contained therein;
said global control interface further including a crate control for sorting a portion of said plurality of media tracks into a set for use at a disc jockey performance; and
a digital mixing controller for accessing and controlling said digital storage device through the respective one of said plurality of input ports according to selections made on said first interface, said second interface and said global control interface.

23. The media player of claim 22, further comprising:
a beat keeper having first display, second display and third display;
said first display indicating the beats of a media track playing on said first deck;
said second display indicating the beats of a media track playing on said second deck;
said third display indicating when the downbeats of the media tracks playing on the first deck and second deck, respectively, occur simultaneously.

24. The media player of claim 22, further comprising a view control, said view control displaying a first track profile of a first media track playing on the first deck juxtaposed to a second track profile of a second media track playing on the second deck on the third portion of the main display screen to provide a graphical representation of the energy to the first media track and the second media track.
